(19) United States
(12) Patent Application Publication
(10) Pub. No.: US 2007/0253377 A1
(43) Pub. Date: Nov. 1, 2007

(54) APPARATUS AND METHOD FOR NAME RESOLUTION IN AN AGGREGATION OF MOBILE NETWORKS

(75) Inventors: Christophe Janneteau, Bois D'Arcy (FR); Alexis Olivereau, Orsay (FR)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/380,832

(22) Filed: Apr. 28, 2006

(51) Int. Cl. H04Q 7/24

(52) U.S. Cl. 370/338

(57) ABSTRACT

A method and apparatus are provided for establishing internet protocol (IP) communication with a node in an aggregation of one or more mobile networks each having a name server. The method includes multicasting (105) at least one message to the mobile networks indicating a name resolution of at least one mobile network in the aggregation, and determining (110) an IP address of the node from the name resolution(s) indicated by the multicasted message(s). The name resolution is based on a domain name of the name server of a corresponding mobile network in the aggregation.

### FIELD OF THE INVENTION

The present invention relates generally to network communications and more particularly to establishing internet protocol (IP) communication with a destination node in an aggregation of mobile networks.

### BACKGROUND

A mobile network is a network whose hosts and routers are usually static (e.g., non-mobile) with respect to each other, but are collectively mobile with respect to the rest of the Internet. For example, a mobile network might be found in an airplane, a ship, or a train. In general, a mobile router provides mobility (e.g., connection to the Internet Protocol (IP) infrastructure) for the nodes attached to the mobile router using, for example, mobile IP or network mobility (NEMO). A specific node in the mobile network is typically designated the mobile router and manages the mobility for all of the nodes within the mobile network, and thus a mobile network can change the point of attachment to the IP infrastructure while maintaining IP communication between nodes inside the mobile network and corresponding nodes connected to the Internet. When the mobile router moves from one IP subnet to another, the mobile router is typically required to handle mobility so as to maintain all of the communication of the nodes attached to the mobile router.

Mobile networks may take a variety of configurations such as a nested mobile network configuration where at least one first mobile network is attached under a second mobile network. For example, the first mobile network may be an individual carrying a device having an associated personal network, and the second mobile network may be a train having a mobile network infrastructure with connectivity to an IP network or infrastructure. When the individual enters the train, the mobile network of the individual can communicatively couple to an access point deployed in the train to operate within the mobile network of the train. Each mobile network has one or more local fixed nodes (LFNs) (e.g., a wireless device) that may be connected to the mobile router of the corresponding mobile network, such as by Ethernet. The LFN has an IP address that belongs to the IP subnet(s) of the mobile network.

Prior to establishing IP communication with a destination node, the destination hostname is resolved into the IP address associated with the destination node, referred to as “name resolution”, unless the IP address is previously known. One or more domain name service (DNS) servers may be used for a successful name resolution and typically involves a set of intermediate DNS servers having connectivity with one another to enable name resolution. For example, a mobile router has connectivity with a first DNS server, and the first DNS server has connectivity with a second DNS server that is authoritative for the destination node.

This name resolution is then used to establish IP communication. Mobile IP supports routing between a node in one mobile network of a group of mobile networks with a node in another mobile network of the group of mobile networks using “home agents” to establish communication between the two nodes. A “home agent” is a node in the IP infrastructure that intercepts communication addressed to a particular LFN and re-directs the communication to the current location of the mobile router associated with the LFN.

In conventional nested mobile networks, while the mobile router having connectivity to the IP infrastructure (e.g., the mobile router of the mobile network at the top of the nested mobile networks or the root mobile router for the nested mobile networks) maintains this connectivity, communication may be established between nodes of the nested mobile networks using conventional mobile IP. When the root mobile router loses this connectivity, the nested mobile networks are isolated and referred to as “autonomous”. In this autonomous mode, the home agents are not reachable by the mobile router. Currently, conventional protocols, such as Mobile IP and NEMO, do not support the transmission of data packets (i.e., routing) between two nodes in an autonomous aggregation. In general, the node initiating the communication may know the fully qualified domain name (FQDN) of the destination node but may not know the IP address of the destination node. With the loss of connectivity to the IP infrastructure, the LFNs of the nested mobile networks lose access to DNS servers (e.g., default DNS servers, authoritative DNS servers, and intermediate DNS servers) that would otherwise be used for name resolution of the FQDN of the destination node into the IP address of the destination node.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an autonomous aggregation of mobile networks in accordance with some embodiments of the invention.

FIG. 2 is a block diagram of an exemplary multicast group in accordance with some embodiments of the invention.

FIG. 3 is a signaling diagram of an exemplary name resolution in a recursive mode.

FIG. 4 is a flow diagram of a first exemplary method for establishing communication between nodes of different mobile networks in an aggregation of one or more mobile networks in accordance with some embodiments of the invention.

FIG. 5 is a flow diagram of a second exemplary method for establishing communication between nodes of different mobile networks in an aggregation of one or more mobile networks in accordance with some embodiments of the invention.

FIG. 6 is a flow diagram of a third exemplary method for establishing communication between nodes of different mobile networks in an aggregation of one or more mobile networks in accordance with some embodiments of the invention.

### DETAILED DESCRIPTION

Before describing in detail embodiments that are in accordance with the present invention, it should be observed that the embodiments reside primarily in combinations of method steps and apparatus components related to establishing communication between nodes in an aggregation of one or more networks and/or sub-networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions for establishing communication between nodes in an aggregation of one or more networks and/or sub-networks as described herein. The non-processor circuits may include, but are not limited to, a radio receiver, a radio transmitter, signal drivers, clock circuits, power source circuits, and user input devices. As such, these functions may be interpreted as steps of a method for establishing communication between nodes in an aggregation of one or more networks and/or sub-networks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

A method and apparatus are provided which enable internet protocol (IP) communication between nodes of different mobile networks in an aggregation of mobile networks. Each mobile network of the aggregation has a domain name and has a domain name service (DNS) server that is authoritative for at least the domain name of the corresponding mobile network. Each DNS server proactively sends multicast messages to a multicast group of DNS servers in the aggregation, and the multicast messages map a DNS server domain name to a corresponding fully qualified domain name (FQDN) and a corresponding IP address. From these multicast messages, nested DNS servers in the aggregation and the respective domain names for which such nested DNS servers are authoritative may be discovered for name resolution of a destination node in the aggregation. This allows any DNS server in the aggregation to obtain information (e.g., name server resource records) to respond to DNS queries targeting an FQDN that matches any of the domain names in the nested mobile networks. Additionally, multicast name resolution may be used to support FQDN resolution for visiting mobile nodes (VMNs) whose home domain is not one of the mobile networks in the aggregation. The method and apparatus can thus provide communication between nodes of different mobile networks in the aggregation when the aggregation is operating in an autonomous mode (e.g., when the aggregation lacks connectivity with an IP infrastructure, such as the Internet). The method and apparatus enable any node in an autonomous aggregation of mobile networks to DNS resolve the FQDN of any other node in the same aggregation into the corresponding IP address. When the aggregation is operating in a connected mode (e.g., when at least one of the mobile networks has connectivity with the IP infrastructure), the method and apparatus can increase the efficiency of the name resolution process.

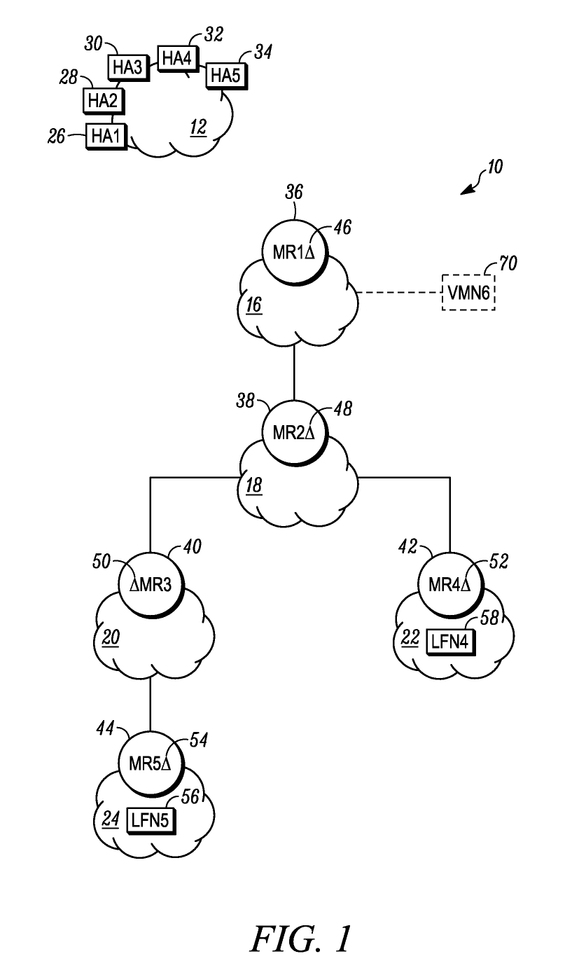

FIG. 1 is a block diagram of an autonomous aggregation 10 of mobile networks in accordance with some embodiments of the invention. The autonomous aggregation 10 comprises mobile networks 16, 18, 20, 22, and 24 in a nested configuration that lack connectivity to an IP infrastructure 12. Although the autonomous aggregation 10 is described as a nested configuration, the autonomous aggregation 10 may have various forms, such as a fully nested, a flat, or a mixed configuration. In this exemplary embodiment, mobile network 24 is coupled to mobile network 20, mobile networks 20 and 22 are coupled to mobile network 18, and mobile network 18 is coupled to mobile network 16. Each of the mobile networks 16, 18, 20, 22, and 24 includes, but is not necessarily limited to, one or more nodes, one or more IP subnets, and a mobile router (MR) 36, 38, 40, 42, and 44, respectively (e.g., MR1, MR2, MR3, MR4, and MR5, respectively). Each of the mobile routers 36, 38, 40, 42, and 44 is associated with a DNS server 46, 48, 50, 52, and 54, respectively, and provides mobility for the nodes attached to the particular mobile router. The IP infrastructure 12 comprises home agents (HA) 26, 28, 30, 32, and 34 (e.g., HA1, HA2, HA3, HA4, and HA5, respectively) that correspond to one or more nodes of each of the mobile networks 16, 18, 20, 22, and 24. In aggregation 10, the home agents 26, 28, 30, 32, and 34 are not reachable by the respective nodes. For example, mobile network 24 has a local fixed node (LFN) 56 (e.g., LFN5) that lacks connectivity with home agent 34 (e.g., HA5), and mobile network 22 has an LFN 58 (e.g., LFN4) that lacks connectivity with home agent 32 (e.g., HA4). Although aggregation 10 is described with five (5) mobile networks, aggregation 10 may comprise any number of mobile networks.

Although not shown, each of the mobile routers 36, 38, 40, 42, 44 comprises a central processing unit having one or more processors (e.g., microprocessors, reduced instruction set computer (RISC) chips, and the like) and a non-volatile memory (e.g., non-volatile random access memory (RAM) and/or read-only memory (ROM), a data storage device, and one or more communication interfaces (e.g., low/medium speed interfaces such as multiport communications interfaces, serial communications interfaces, or a token ring interface, high speed interfaces such as multiport Ethernet interfaces, wireless interfaces, and the like) typically provided as interface cards. The communication interfaces control communication intensive tasks such as packet switching and filtering, and media control and management. It will be appreciated by those of ordinary skill in the art that the mobile routers 36, 38, 40, 42, and 44 may have a variety of other router architectures.

The mobile routers 36, 38, 40, 42, and 44 are collocated with the associated DNS server 46, 48, 50, 52, and 54 and coupled via a communication bus. Alternatively, one or more of the DNS servers 46, 48, 50, 52, and 52 may reside at a different node supported by the corresponding mobile router within the corresponding mobile network. Although each of the mobile networks 16, 18, 20, 22, and 24 has a corresponding mobile router 36, 38, 40, 42, and 44, respectively, one or more of the mobile networks 16, 18, 20, 22, 24 may include additional mobile routers. In an exemplary embodiment, each DNS server 46, 48, 50, 52, 54 is authoritative for the domain name of the corresponding mobile network 16, 18, 20, 22, and 24 and may be authoritative for other domain names of the mobile networks 16, 18, 20, 22, and 24 in the aggregation 10. For example, the DNS server 52 collocated on MR4 42 is authoritative for the domain name of the mobile network 22 (e.g., nemo4.cen4.com) and thus, manages a zone file encompassing the FQDN of any LFN (e.g., LFN4 58 with an FQDN of LFN4.nemo4.cen4.com) and any mobile node having the mobile network 22 as a home network. Each of the DNS servers 46, 48, 50, 52, and 54 have a corresponding IP address and a corresponding domain name associated therewith. For example, the DNS server 46 has a domain name (e.g. MR1.nemo1.cen1.com) and an IP address (e.g. MR1@).

The DNS servers 46, 48, 50, 52, 54 of the aggregation 10 all belong to a multicast group, and each DNS server 46, 48, 50, 52, 54 includes a memory having one or more DNS caches, one or more multicast name resolution (MNR) caches, and one or more zone files for storing resource records (RRs). The RRs include, but are not necessarily limited to, a name server resource record (“NS” RR) and an IP address resource record (“A” RR). Each DNS server 46, 48, 50, 52, 54 manages an “NS” RR that maps the domain name served by the particular DNS server to the name of the particular DNS server. For example, for mobile network 22, the “NS” RR managed by DNS server 52 is nemo4.cen4.com which maps to MR4.nemo4.cen4.com. Additionally, each DNS server 46, 48, 50, 52, 54 manages one or more “A” RRs for each node whose home network is the corresponding mobile network 16, 18, 20, 22, 24, respectively, and each “A” RR maps the FQDN of a node to a corresponding IP address. For example, for LFN4 58 in mobile network 22, the “A” RR is LFN4.nemo4.cen4.com which maps to LFN4@. Using the zone file, the DNS server of a particular mobile network can authoritatively respond to any DNS query relating to the nodes of the corresponding mobile network. Additionally, each DNS server 46, 48, 50, 52, 54 is configured to store a server list (SLIST) of “NS” RRs and “A” RRs to identify the other DNS servers in the aggregation 10 with corresponding “NS” RRs and “A” RRs associated therewith.

Additionally, at times, one or more “new” mobile nodes may visit a mobile network of the aggregation 10. For example, a visiting mobile node 70 (e.g., VMN6) may communicatively couple to mobile network 16. In this exemplary embodiment, the visiting mobile node has a corresponding hostname and a corresponding IP address and registers these with the DNS server of the visited mobile node. For example, VMN6 70 registers a host name (vmn6.cen6.com) and an IP address (vmn6_IP@) with DNS server 46 of mobile network 16, and this information is stored in the DNS cache of DNS server 46. MR1 36 can use this information to respond to multicast MNR queries on behalf of VMN6 70. In another exemplary embodiment, the visiting mobile node 70 joins the multicast group of DNS servers 46, 48, 50, 52, 54 to directly respond to multicast MNR queries targeting the visiting mobile node 70.

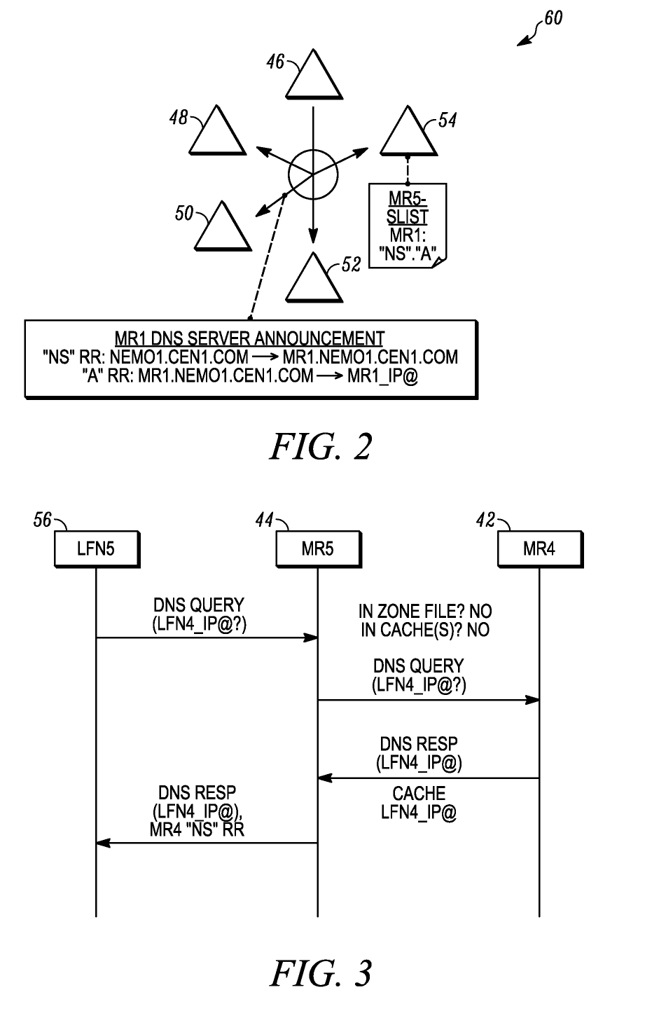

FIG. 2 is a block diagram of an exemplary multicast group 60 in accordance with some embodiments of the invention. Each DNS server 46, 48, 50, 52, 54 subscribes to the multicast group 60 for receiving messages from other DNS servers of the multicast group 60. The scope of the multicast group 60 is preferably large enough to spread over the entire aggregation 10. The DNS servers 46, 48, 50, 52, 54 are configured to proactively send (e.g., via periodically scheduled transmissions) multicast messages to the multicast group 60 to indicate the presence of the DNS server, as well as the domain name for which the DNS server is authoritative, to the other DNS servers of the multicast group 60. Based on the messages received from the other DNS servers of the multicast group 60, each DNS server 46, 48, 50, 52, 54 updates the corresponding SLIST. The message includes, but is not necessarily limited to, the domain name for which the sending DNS server is authoritative, the FQDN of the sending DNS server, and the IP address of the sending DNS server. This message may be implemented as a standard DNS response message having an “NS” RR (e.g., indicating the domain name and the FQDN of the sending DNS server) and an “A” RR (e.g., indicating the FQDN and the IP address of the sending DNS server). For example, a message sent by the DNS server 46 collocated with MR1 36 includes an “NS” RR mapping the name space of the mobile network 16 (nemo1.cen1.com) to the FQDN of MR1 36 (MR1.nemo1.cen1.com) and an “A” RR mapping the FQDN of MR1 36 (MR1.nemo1.cen1.com) to the IP address of MR1 42 (MR1@).

In one exemplary embodiment, the message includes a lifetime specifying the amount of time the corresponding entry (e.g., the “NS” RR and “A” RR of the sending DNS server) is to be kept in the SLIST of another DNS server receiving the message. The RR may have a Time-To-Live (TTL) field to implement this lifetime. These messages can also be sent periodically while the DNS server is part of the aggregation 10 and based on the TTL value set in the RRs of the message.

In another exemplary embodiment, the SLIST includes a “nested” flag that can be set to indicate that a DNS server has been discovered through the messages received from the multicast group 60 and that the DNS server is in the aggregation 10. Using the “nested” flag distinguishes these entries (e.g., the received “NS” RR and “A” RR corresponding to the discovered DNS server) from other entries that have been pre-configured in the SLIST.

Using the proactively sent messages, each DNS server 46, 48, 50, 52, 54 in the aggregation 10 has an SLIST that includes the other DNS servers in the aggregation 10 and the domain names for which those DNS servers are authoritative. The DNS servers 46, 48, 50, 52, 54 can respond to any DNS queries targeting any node having a home domain that is one of the mobile networks 16, 18, 20, 22, 24 of the aggregation 10. In an exemplary embodiment of a name resolution in an iterative mode, a DNS server in the aggregation 10 receives a DNS query from a requesting node (e.g., a node in the mobile network of the DNS server) for the FQDN of a destination node. This DNS server sends a DNS response to the requesting node that includes a referral (e.g., “NS” and “A” RRs) to the authoritative DNS server (e.g., as indicated by the SLIST) for the FQDN targeted by the DNS query (e.g, the destination node). The requesting node then pursues the name resolution with this authoritative DNS server.

In an exemplary embodiment of a name resolution in a recursive mode, the DNS server receiving the DNS query pursues the name resolution by contacting the authoritative DNS server (e.g., indicated by the SLIST) for the FQDN targeted by the DNS query. The requesting node does not pursue the authoritative DNS server in the recursive mode. Once a response is received from the authoritative DNS server, the DNS server caches the RRs received from the authoritative DNS server in the DNS cache and sends the response to the requesting node. This response includes an “A” RR mapping the FQDN of the destination node to the corresponding IP address. Additionally, the DNS server can include a referral to the authoritative DNS server in the response to the requesting node (e.g., in the form of “NS” and “A” RRs), so that subsequent queries for the same domain are sent directly by the requesting node to this authoritative DNS server.

FIG. 3 is a signaling diagram illustrating an exemplary name resolution in a recursive mode. The LFN5 56 sends a DNS query to MR5 44 seeking to resolve the destination name of LFN4 58 into the IP address for LFN4 58 (e.g., LFN4_IP@?). In response to this DNS query, MR5 44 searches the zone file and cache(s) of MR5 44 for the IP address of LFN4 58 (e.g., an “A” RR for LFN4 58). When the zone file and cache(s) of MR5 44 do not have the IP address of LFN4 58, MR5 44 sends a DNS query to MR4 42 (e.g., since the SLIST of MR5 indicates MR4 as authoritative for the domain name which includes the FQDN of LFN4) seeking the same name resolution of LFN4 58 (e.g., LFN4_IP@?). Since MR4 42 is authoritative for the domain names of mobile network 22, which includes LFN4 58, MR4 42 sends a DNS response to MR5 44 with the IP address of LFN4 58. MR5 44 updates the DNS cache of MR5 44 with the IP address of LFN4 58 and sends a DNS response to LFN5 56 with the IP address of LFN4 58 and, optionally, a referral to the DNS server 52 of MR4 42 (e.g., the “NS” RR for MR4).

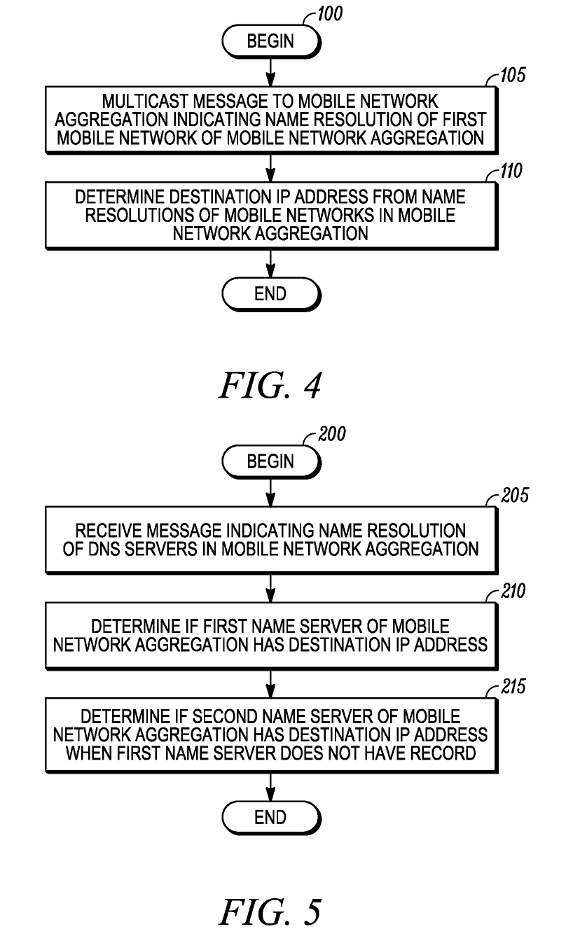

FIG. 4 is a flow diagram of a first exemplary method 100 for establishing communication between nodes of different mobile networks in an aggregation of one or more mobile networks in accordance with some embodiments of the invention. Each of the mobile networks in the aggregation has a DNS server authoritative for at least one domain name. At least one message is multicast to the aggregation at step 105. The message(s) indicates a name resolution of at least one mobile network of the aggregation and is based on the domain name of the DNS server of such mobile network(s) of the aggregation. In an exemplary embodiment, each of the mobile networks in the aggregation has a domain name, and each of the DNS servers of the mobile network(s) in the aggregation is authoritative for at least a domain name of a corresponding mobile network in the aggregation. The message(s) matches each DNS server of the mobile networks of the aggregation with a different domain name and a different IP address. For example, a first mobile network of the aggregation has a first DNS server authoritative for a first domain name, and the first DNS server has a first FQDN and a first IP address. In this example, a first message is multicast from the first mobile network to the aggregation, and the first message indicates the first domain name, the first FQDN, and the first IP address. The first message may also indicate the domain name, FQDN, and IP address for other DNS servers in the aggregation.

A destination IP address is determined from the name resolutions of the mobile networks in the aggregation at step 110. In one exemplary embodiment, a determination is made as to one of the DNS servers of the one or more mobile networks being authoritative for the destination IP address. A multicast name resolution (MNR) query for the destination IP address is sent when no DNS servers of the one or more mobile networks is authoritative for the destination IP address. In another exemplary embodiment, a DNS query for the destination IP address is unicast, and an MNR query for the destination IP address is multicast when the DNS query does not provide a response indicating the destination IP address. Additionally, a list, based on the at least one message, may be updated after the step of multicasting 105. Each of the DNS servers of the one or more mobile networks has a domain name, a FQDN, and an IP address associated therewith. The list identifies at least one of the DNS servers of the one or more mobile networks with a corresponding domain name, a corresponding FQDN, and a corresponding IP address. Additionally, an announcement may be multicast to the aggregation when a new mobile network joins the autonomous aggregation, the announcement indicating a name resolution of the new mobile network.

FIG. 5 is a flow diagram of a second exemplary method 200 for establishing communication between nodes of different mobile networks in an aggregation of one or more mobile networks in accordance with some embodiments of the invention. Each of the one or more mobile networks has a DNS server authoritative for at least one domain name. In this exemplary embodiment, a first message is multicast to the one or more mobile networks indicating a name resolution of a first DNS server based on the domain name of a first mobile network of the aggregation. A second message is received indicating a name resolution of at least one DNS server of the one or more mobile networks at step 205. The name resolution is based on the domain name of such DNS server(s) of the one or more mobile networks. A server list of the first DNS server, based on the name resolution of the DNS server(s), may be updated after the receiving step 205. A determination is made as to the first DNS server having a record based on the destination IP address at step 210. In one exemplary embodiment, the first DNS server has a zone file, a DNS cache, and an MNR cache. The record is searched for among the zone file, DNS cache, and MNR cache in response to a unicast query for the record, and a response, indicating the record, is sent when the record is found among one of the zone file, DNS cache, and MNR cache. In one exemplary embodiment, the record is searched for among the zone file and the DNS cache in response to a multicast query for the record. A first response is sent when the record is found in the zone file of the first DNS server, the first response indicating the record and a referral to the first DNS server. A second response is sent when the record is found in the DNS cache of the first DNS server, the second response indicating the record.

A determination is made if a second DNS server of the one or more mobile networks has the record when the first DNS server does not have a record indicating the destination IP address at step 215. In one exemplary embodiment, the first DNS server has a server list, and the server list is searched for an authoritative DNS server of the IP address when the record is absent among the zone file, DNS cache, and MNR cache of the first DNS server. In another exemplary embodiment, a request for the record is multicast to the one or more mobile networks when the server list of the first DNS server does not have a name server authoritative for the IP address and when the first DNS server does not have the record. A first response to this request, indicating the record, may be received, and the MNR cache of the first DNS server is updated with the record. The first response may also indicate a referral to the second DNS server when the second DNS server has the record. In this case, the MNR cache of the first DNS server is updated with the record, and the server list of the first DNS server is updated with an entry for the second DNS server and a nested flag. The entry is based on the referral to the second DNS server. In another exemplary embodiment, when the server list of the first DNS server has a nested flag set for the second DNS server, indicating the second DNS server as authoritative for the IP address, a query is sent to the second name server for the record. The DNS cache of the first DNS server is updated after receiving a response from the second DNS server to this query, and the nested flag is unset when the second DNS server does not respond to the query.

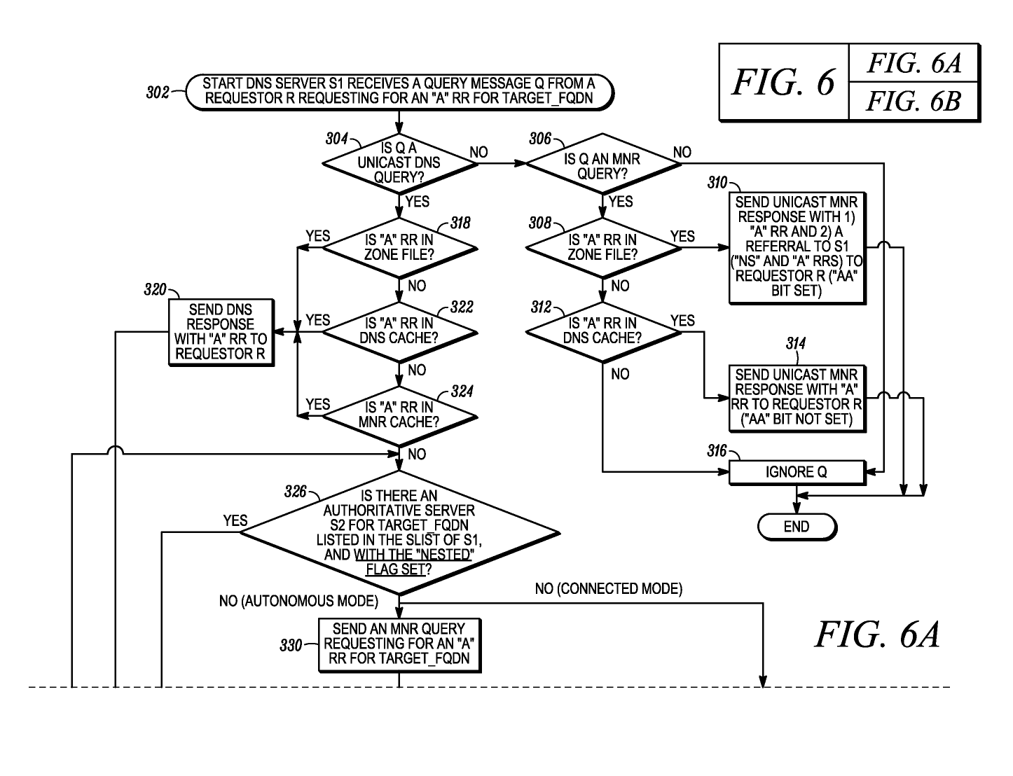

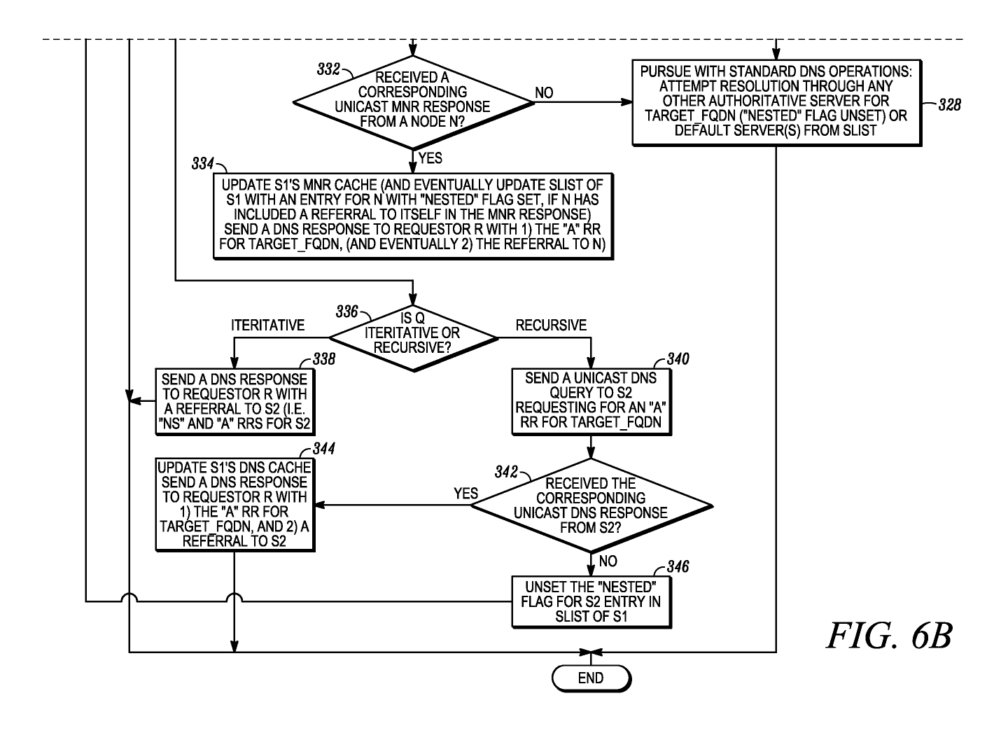

FIG. 6 is a flow diagram 300 of a third exemplary method for establishing communication between nodes of different mobile networks in an aggregation of one or more mobile networks in accordance with some embodiments of the invention. A query message (e.g., Q) is received by a first DNS server (e.g., S1) from a requestor (e.g., R) that requests an “A” RR for a destination node (e.g., TARGET_FQDN) at step 302. A determination is made as to the query message (Q) being a DNS query at step 304. When the query message is not a DNS query, a determination is made as to the query message being an MNR query at step 306. When the query message is not an MNR query, the query message is ignored at step 316, and the method 300 ends. When the query message is an MNR query, a determination is made as to the “A” RR being in the zone file of the first DNS server at step 308. When the “A” RR is in the zone file of the first DNS server, an MNR response is unicast to the requestor at step 310, the MNR response including the “A” RR and a referral to the first DNS server which includes the “NS” RR and “A” RR of the first DNS server, and the method 300 ends. When the “A” RR is not in the zone file of the first DNS server, a determination is made as to the “A” RR being in the DNS cache of the first DNS server at step 312. When the “A” RR is in the DNS cache of the first DNS server, an MNR response is unicast to the requester at step 314, the MNR response including the “A” RR, and the method 300 ends. When the “A” RR is not in the DNS cache of the first DNS server, the first DNS server ignores the query message at step 316 and the method 300 ends.

When the query message is a DNS query, a determination is made as to the “A” RR being in the zone file of the first DNS server at step 318. When the “A” RR is not in the zone file of the first DNS server, a determination is made as to the “A” RR being in the DNS cache of the first DNS server at step 322. When the “A” RR is not in the DNS cache of the first DNS server, a determination is made as to the “A” RR being in the MNR cache of the first DNS server at step 324. When the “A” RR is found in any one the zone file, DNS cache, and MNR cache of the first DNS server, a DNS response, having the “A” RR, is sent to the requester at step 320, and the method 300 ends. When the “A” RR is not found in the MNR cache of the first DNS server, a determination is made as to a second DNS server (e.g., S2), authoritative for the destination node, being listed in the server list (e.g., SLIST) of the first DNS server and with the nested flag set at step 326. In a connected mode (e.g., at least one mobile router of the aggregation having connectivity with the IP infrastructure), when no second DNS server is found in the server list of the first DNS server that is authoritative for the destination node, standard DNS operations are performed to name resolve the destination node at step 328 (e.g., using any authoritative DNS server for TARGET_FQDN or default DNS server(s) from SLIST), and the method ends 300. In an autonomous mode (e.g., no mobile routers having connectivity with the IP infrastructure), an MNR query is sent requesting the “A” RR for the destination node at step 330. A determination is made as to a corresponding MNR response being received from another node (e.g., N) at step 332. When no corresponding MNR response is received, standard DNS operations are performed at step 328. When a corresponding MNR response is received, the MNR cache of the first DNS server is updated, a DNS response is sent to the requester with the “A” RR for the destination node at step 334, and the method 300 ends. Additionally, the server list of the first DNS server is updated with an entry for the node (N) with a nested flag set when the node (N) includes a self-referral in the MNR response. In this case, the DNS response to the requester also include the referral to the node (N).

When a second DNS server that is authoritative for the destination node is found in the server list of the first DNS server, a determination is made as to the query message being iterative or recursive at step 336. When the query message is iterative, the first DNS server sends a DNS response to the requester with a referral to the second DNS server (e.g., including the “NS” RR and “A” RR for S2) at step 338, and the method 300 ends. When the query message is recursive, the first DNS server unicasts a DNS query to the second DNS server requesting the “A” RR for the destination node at step 340. A determination is made as to a corresponding unicast DNS response being received from the second DNS server at step 342. When the corresponding unicast DNS response is received from the second DNS server, the DNS cache of the first DNS server is updated, the first DNS server sends a DNS response to the requestor with the “A” RR for the destination node and a referral to the second DNS server at step 344, and the method 300 ends. When no corresponding unicast DNS response is received, the nested flag for the second DNS server in the server list of the first DNS server is unset at step 346, and the first DNS server continues to step 326.

In the foregoing specification, specific embodiments of the present invention have been described. However, one of ordinary skill in the art appreciates that various modifications and changes can be made without departing from the scope of the present invention as set forth in the claims below. For example, while the description above describes communication between nodes in an autonomous aggregation of networks, it should be appreciated that these concepts can also be applied, for example, to aggregations of networks having IP connectivity and having a fully nested, flat, mixed, or other aggregation configuration.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for establishing internet protocol (IP) communication with a node in an autonomous aggregation of one or more mobile networks, each of the one or more mobile networks having a name server authoritative for at least one domain name, the method comprising:
multicasting at least one message to the one or more mobile networks, the at least one message indicating a name resolution of at least one mobile network of the one or more mobile networks based on a domain name associated with the name server of the at least one mobile network; and
determining a destination IP address for the node from the name resolution of the at least one mobile network of the one or more mobile networks.

2. A method according to claim 1, wherein each of the one or more mobile networks has a domain name associated therewith, and wherein the name server of the at least one of the one or more mobile networks is authoritative for at least the domain name of the at least one or more mobile networks.

3. A method according to claim 1, wherein the at least one message matches each name server of the at least one mobile network of the one or more mobile networks with a different domain name and a different IP address.

4. A method according to claim 1, wherein a first mobile network of the one or more mobile networks has a first name server authoritative for a first domain name, the first name server having a first fully qualified domain name (FQDN) and a first IP address associated therewith, and wherein said step of multicasting comprises multicasting a first message of the at least one message from the first mobile network to the one or more mobile networks, the first message including information indicating the first domain name, the first FQDN, and the first IP address.

5. A method according to claim 1 further comprising after said step of multicasting the step of updating a list based on the at least one message, wherein each of the name servers of the one or more mobile networks has a domain name, a FQDN, and an IP address associated therewith, the list identifying at least one of the name servers of the one or more mobile networks with a corresponding domain name, a corresponding FQDN, and a corresponding IP address, the list having a nested flag indicating a discovered name server and the discovered name server being in the autonomous aggregation of the one or more mobile networks.

6. A method according to claim 1, wherein said step of determining comprises:
determining if a name server of the one or more mobile networks is authoritative for a destination FQDN; and
sending a multicast name resolution (MNR) query for the destination FQDN when no name server of the one or more mobile networks is authoritative for the destination FQDN.

7. A method according to claim 1, wherein said step of determining comprises:
unicasting a domain name service (DNS) query for a destination IP address associated with a destination FQDN; and
multicasting an MNR query for the destination IP address when the DNS query does not provide a response indicating the destination IP address.

8. A method according to claim 1 further comprising multicasting an announcement to the one or more mobile networks in response to a new mobile network joining the autonomous aggregation of the one or more mobile networks, the announcement indicating a name resolution of the new mobile network.

9. A method for resolving an internet protocol (IP) address of a node in an autonomous aggregation of one or more mobile networks, each of the one or more mobile networks having a name server authoritative of at least one domain name associated therewith, the method comprising:
multicasting a first message to the one or more mobile networks, the first message indicating a name resolution of a first name server based on one of the at least one domain name associated with a first mobile network of the one or more mobile networks;
receiving a second message indicating a name resolution of at least one name server associated with a first one of the one or more mobile networks, the name resolution based on the domain name associated with the at least one name server;
determining whether the first name server has a record stored therein, the record indicating the IP address of the node; and
determining whether a second name server associated with a second one of the one or more mobile networks has the record stored therein in response to determining that the first name server does not have the record stored therein.

10. A method according to claim 9 further comprising after said receiving step updating a server list of the first name server in response to the name resolution of the at least one name server associated with the first one of the one or more mobile networks.

11. A method according to claim 9 further comprising prior to said step of determining whether the first name server has the record receiving a unicast query for the record;
wherein the first name server includes a zone file, a DNS cache, and an MNR cache, and said step of determining whether the first name server has the record comprises searching for the record among the zone file, the DNS cache, and the MNR cache in response to the unicast query for the record; and
wherein the method further comprising sending a response when the record is found among one of the zone file, the DNS cache, and the MNR cache, the response including information indicating the record.

12. A method according to claim 11, wherein the first name server further includes a server list, and wherein said step of determining whether a second name server associated with a second one of the one or more mobile networks has the record comprises searching the server list for a name server authoritative for an FQDN of the node when the record is absent among the zone file, the DNS cache, and the MNR cache of the first name server.

13. A method according to claim 9, wherein the first name server has a zone file, a DNS cache, an MNR cache, and a server list, and wherein said step of determining whether a second name server associated with a second one of the one or more mobile networks has the record comprises multicasting a request for the record to the one or more mobile networks when the server list of the first name server does not have a name server authoritative for an FQDN of the node and when the first name server does not have the record stored therein.

14. A method according to claim 13, wherein said step of determining whether a second name server associated with a second one of the one or more mobile networks has the record further comprises:
receiving a first response to the request, the first response including information indicating the record; and
updating the MNR cache of the first name server with the record.

15. A method according to claim 13, wherein said step of determining whether a second name server associated with a second one of the one or more mobile networks has the record further comprises:
receiving a first response to the request, the first response including information indicating the record and a reference to the second name server;
updating the MNR cache of the first name server with the record; and
updating the server list of the first name server with an entry for the second name server and a nested flag, the entry including information indicating the reference to the second name server.

16. A method according to claim 9, wherein the first name server has a DNS cache and a server list, the server list having a nested flag set for the second name server and indicating the second name server as a name server authoritative for an FQDN of the node, and wherein said step of determining whether a second name server associated with a second one of the one or more mobile networks has the record comprises:
sending a query for the record to the second name server;
updating the DNS cache of the first name server after receiving a response from the second name server to the query; and
unsetting the nested flag of the server list of the first name server in response to the second name server not responding to the query.

17. A method according to claim 9, wherein the first name server has a zone file and a DNS cache, and wherein said step of determining whether the first name server has a record comprises:
receiving a multicast query for the record;
searching for the record among the zone file and the DNS cache in response to the multicast query for the record;
sending a first response in response to the record being stored in the zone file, the first response including information indicating the record and a reference to the first name server; and
sending a second response in response to the record being stored in the DNS cache, the second response including information indicating the record.

18. A domain name service (DNS) server for a first mobile network in an aggregation of one or more mobile networks, the DNS server authoritative for at least one domain name, the DNS server comprising:
a processing device configured to:
multicast a first message to the one or more mobile networks, said first message indicating a name resolution of the first mobile network based on said at least one domain name;
receive a second message from each of the one or more mobile networks, said second message indicating a name resolution for each of the one or more mobile networks; and
support a name resolution of a node in the aggregation of one or more mobile networks.

19. A DNS server according to claim 18 further comprising a memory coupled to said processing device, said memory comprising a server list indicating a DNS server for each of the one or more mobile networks and identifying name servers for each of the one or more mobile networks with a corresponding domain name, a corresponding fully qualified domain name (FQDN), and a corresponding internet protocol (IP) address.

20. A DNS server according to claim 19, wherein said node has a destination IP address and a destination FQDN associated therewith, and wherein said processing device is further configured to multicast a multicast name resolution (MNR) query for said destination IP address when said server list does not have an authoritative name server for said destination FQDN, said MNR query including information indicating said destination FQDN.

21. A DNS server according to claim 18, wherein said node has a destination IP address associated therewith, and wherein said processing device is further configured to:
unicast a DNS query for said destination IP address; and
multicast an MNR query for said destination IP address when a response to said DNS query indicating said destination IP address is not received.

22. A DNS server according to claim 18 further comprising a memory coupled to said processing device, said memory comprising a zone file, a DNS cache, an MNR cache, and a server list; wherein said node has a destination IP address and a destination FQDN associated therewith; and wherein said processing device is further configured to:
receive a query for said destination IP address from a second DNS server in the aggregation of one or more mobile networks;
search for a record among at least one of said zone file, said DNS cache, and said MNR cache, said record including information indicating said destination IP address;
send a response to said node when said record is found among one or more of said zone file, said DNS cache, and said MNR cache, said response including information indicating said record; and
search said server list for an authoritative name server of said destination FQDN when said record is absent from said zone file, said DNS cache, and said MNR cache.

23. A DNS server according to claim 18, wherein the first mobile network comprises a mobile router, and wherein the DNS server is collocated with said mobile router.

24. A method for establishing internet protocol (IP) communication with a node in an aggregation of one or more mobile networks, at least one mobile network of the aggregation coupled to an IP infrastructure, each of the one or more mobile networks having a name server authoritative for at least one domain name, the method comprising:
multicasting at least one message to the one or more mobile networks, the at least one message including information indicating a name resolution of at least one mobile network of the one or more mobile networks based on a domain name associated with the name server of the at least one mobile network; and
determining a destination IP address of the node from the name resolution of at least one mobile network of the one or more mobile networks.

25. A method according to claim 24, wherein each of the one or more mobile networks has a domain name corresponding thereto, wherein the name server of at least one of the one or more mobile networks is authoritative for at least the domain name of the corresponding mobile network, the method further comprising prior to said step of determining unicasting a domain name service (DNS) query for the destination IP address.

26. A method according to claim 24 further comprising after said step of multicasting updating a list in response to the at least one message, wherein each of the name servers of the one or more mobile networks has a domain name, a FQDN, and an IP address associated therewith, the list identifying at least one of the name servers of the one or more mobile networks with a corresponding domain name, a corresponding FQDN, and a corresponding IP address.

27. A method according to claim 24, wherein said step of determining comprises determining if one of the name servers of the one or more mobile networks is authoritative for a destination FQDN of the node.

28. A method according to claim 24, wherein said step of determining comprises sending a DNS response with a reference to a first name server of the one or more mobile networks when the first name server of the one or more mobile networks is authoritative for the destination FQDN of the node.

29. A method according to claim 24 further comprising prior to said step of determining the destination IP address of the node:
determining whether a first name server of the one or more mobile networks is authoritative for a destination FQDN of the node; and
unicasting a DNS query for the destination IP address to a first name server of the one or more mobile networks in response to determining that a second name server of the one or more mobile networks is authoritative for the destination FQDN.

30. A method according to claim 24, wherein a first name server of the one or more mobile networks has a zone file, a DNS cache, and an MNR cache, and wherein said step of determining comprises:
receiving a unicast query for the destination IP address;
searching for the destination IP address among the zone file and the DNS cache in response to the unicast query for the destination IP address; and
sending a response when the destination IP address is found among one of the zone file and the DNS cache, the response including information indicating the destination IP address.
